(19) United States
(12) Patent Application Publication
(10) Pub. No.: US 2012/0207886 A1
(43) Pub. Date: Aug. 16, 2012

(54) System and method of preparing frozen baking items

(76) Inventors: Carolyn Shulevitz, Miami Beach, FL (US); Leslie Kaplan, Miami Beach, FL (US)

(21) Appl. No.: 13/374,968

(22) Filed: Jan. 25, 2012

Related U.S. Application Data
(60) Provisional application No. 61/435,962, filed on Jan. 25, 2011.

(51) Int. Cl. A21D 10/02; B65D 85/72

(52) U.S. Cl. 426/115; 426/393

(57) ABSTRACT

A method of preparing a frozen mixture that may be thawed and baked without adding additional ingredients is provided. A mixture is prepared, placed into an oversized pastry bag, and frozen. Air is evacuated from the bag which is then heat sealed. The frozen mixture can be distributed for purchase by customers at retail outlets. The product can be thawed, kneaded, and piped from the bag directly into a baking mold. If desired, flavoring or other ingredients may be added during or following the thawing stage, and can be kneaded prior to piping.

This application claims priority from U.S. provisional patent application Ser. No. 61/435,962, filed Jan. 25, 2011.

### BACKGROUND

This application relates generally to frozen cake batter and, more specifically, to a kit that includes frozen cake batter and distribution of frozen cake batter.

A cupcake is a small cake that typically serves one person. Cupcake batter can be placed in a cupcake pan and baked in an oven to yield the cupcake. The baked cupcake can be covered with frosting or other types of decorations.

Conventionally, cake batter was made by a baker by following a recipe to combine various ingredients. For instance, the recipe could involve combining raw ingredients such as sugar, eggs, flour, salt, or the like according to a given ratio. However, for one who desires to bake cakes at home, combining the raw ingredients according to a recipe can be time consuming, messy, or difficult, while oftentimes involving use of various kitchen utensils (e.g., mixing bowl, measuring cup, measuring spoon, etc.). If the recipe is not followed, the quality of the cake can be less than satisfactory.

Another typical approach for making cake batter involves starting from a cake mix. The cake mix can include a plurality of nonperishable raw ingredients premixed and sold in a kit on a shelf (e.g., in a grocery store, etc.). A consumer purchasing the kit commonly combines the cake mix with additional ingredients (e.g., eggs, oil, etc.) in accordance with a recipe accompanying the kit. However, the consumer again combines the additional ingredients with the cake mix using various kitchen utensils to yield the cake batter, which can be time consuming, messy, or difficult for the consumer.

### SUMMARY OF THE INVENTION

In accordance with one or more embodiments, and corresponding disclosure hereof, various aspects are described that relate to a kit that can include a premixed, unbaked, and ready for baking mixture of ingredients for bakery goods, contained in a pastry bag, wherein the mixture comprises at least one of batter, dough, or filling. The premixed, unbaked, and ready for baking mixture of ingredients for bakery goods packaged in the pastry bag is provided in a frozen state, and is distributed for sale in a freezer section of a retail establishment. When baked goods are desired, a customer can thaw the frozen mixture, pipe the thawed mixture from the pastry bag without adding additional ingredients, and bake the mixture. According to an embodiment, the consumer has the option to customize the flavor of the mixture by adding flavoring or other ingredients to the mixture while it is in the pastry bag and prior to piping the mixture into a mold or pan.

According to other aspects, a method of distributing a pre-mixed, unbaked, and ready for baking mixture of ingredients for bakery goods is described herein. The method can include mixing, dispensing, freezing, evacuating air, heat sealing and packaging a pre-mixed, unbaked, and ready for baking mixture of ingredients for bakery goods in a pastry bag, wherein the mixture of ingredients comprises at least one of batter, dough, or filing. An additional benefit of the invention is that the steps of evacuating air, heat sealing and freezing the mixture of ingredients help to maintain quality and shelf life of the composition. Further, the method can include distributing the frozen mixture of ingredients for sale to consumers in a freezer section of a retail establishment.

Pursuant to further aspects of the invention, the kit can include point of sale packaging. Moreover, the kit can include a pastry bag within the point of sale packaging. In some embodiments, the pastry bag may be oversized, and may include custom printed separation lines to signify to the consumer where to properly cut the tip of the pastry bag for piping the mixture and where to cut at the top of the pastry bag to allow for the addition of flavoring or other ingredients. In these embodiments, an oversized pastry bag permits the addition of other ingredients while still leaving enough room to re-close the pastry bag and to knead the mixture prior to piping. A separate closure device may also be included in the kit. Alternatively, the pastry bag may be manufactured with a zip-lock style zipper for closing the bag. The kit may include a pre-mixed, unbaked, and ready for baking mixture of ingredients within the pastry bag, wherein the mixture of ingredients, which may comprise at least one of batter, dough, or filing, is kept in a frozen state until readied for use.

This summary does not provide an extensive overview of the systems and methods discussed herein, and is not intended to identify key or critical elements, or to delineate the scope of such systems and methods. Its sole purpose is to present some concepts in a simplified form as a prelude to the more detailed description that is presented below.

### BRIEF DESCRIPTION OF THE DRAWINGS

The claimed subject matter may take physical form in certain parts and arrangement of parts, embodiments of which will be described in detail in this specification and illustrated in the accompanying drawings which form a part hereof and wherein:

FIG. 1 illustrates an example kit that includes a mixture of ingredients for bakery goods according to various aspects of the claimed subject matter; and

FIG. 2 illustrates a methodology for distributing and using a pre-mixed, unbaked, and ready for baking mixture of ingredients for bakery goods.

### DETAILED DESCRIPTION OF THE PREFERRED EMBODIMENTS

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident; however, that such aspect(s) may be practiced without these specific details. In other instances, well-known structures and devices are shown in block diagram form in order to facilitate describing one or more aspects.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

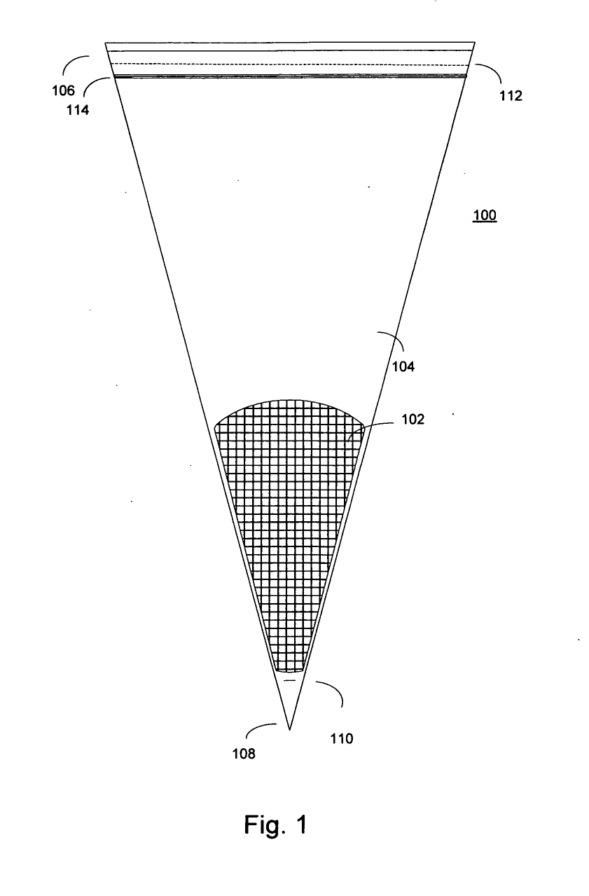

Referring now to the drawings, FIG. 1 illustrates an example kit 100 according to various aspects of the claimed subject matter. The kit 100 includes a mixture 102 that is in a frozen state when sold to consumers. The mixture 102 comprises pre-mixed ingredients for bakery goods sold pre-packaged to consumers. In an embodiment, the pre-mixed ingredients may be all natural ingredients, but the invention is not limited thereto. Moreover, the mixture 102 is packaged in a large pastry bag 104. According to an embodiment, the mixture 102 can be a pre-mixed, unbaked, and ready for baking mixture of ingredients for bakery goods. In an embodiment, the pre-mixed, unbaked, and ready for baking mixture can comprise batter, dough, filling, or the like. For instance, the batter can be cake batter (e.g., cupcake batter, etc.), brownie batter, or the like. In other embodiments, the pre-mixed, unbaked, and ready for baking mixture can comprise a filling (e.g., pie filling), mousse, or other desserts, which may be sweet and savory such as a quiche. In other embodiments, the mixture 102 can be a pre-mixed mixture of ingredients for bakery goods that can comprise frosting. The frosting, for instance, can be buttercream. While the buttercream can be used as frosting, it is also contemplated that the buttercream can be used as a dessert filling or in any other desired confection.

In a preferred embodiment, the pastry bag 104 is oversized and is generally triangular in shape. An edge 106 of the pastry bag 104 may be heat sealed after the bag is evacuated to lock out air. In accordance with an embodiment, the pastry bag 104 can be made of polyethylene, or any other suitable material that prevents or reduces the passage of air into the bag. Further, when the pastry bag 104 is filled with the mixture 102, at least a portion of the pastry bag 104 may form a vertex 108, and can be generally conically shaped; however, it is contemplated that any other shape is intended to fall within the scope of the hereto appended claims.

At a point near the vertex 108, the pastry bag 104 may include a vertex separation line 110. The vertex separation line 110 can be a dotted line or any other visual signifier to indicate to a consumer a location at which the pastry bag 104 can be cut to allow for piping of the mixture 102 from the pastry bag 104. Thus, the consumer can remove a portion of the pastry bag 104 near the vertex 108 by employing a cutting utensil such as, for instance, a knife, scissors, or the like. According to an embodiment, the top separation line 112 can be a dotted line or any visual signifier used to indicate to a consumer a second location at which pastry bag 104 can be cut at the top for insertion of additional ingredients, where desired.

Moreover, although not shown, the pastry bag 104 filled with the mixture 102 can be packaged in point of sale packaging. The point of sale packaging can be included in the kit 100. For instance, the point of sale packaging can be a box, bag, or the like. Moreover, the pastry bag 104 filled with the mixture 102 can be enclosed within the point of sale packaging. The point of sale packaging can have images, text, etc. printed thereon; for example, a picture of the bakery goods yielded from the mixture 102, nutritional information, product name, instructions, or the like can be printed on the point of sale packaging. Accordingly, by including the point of sale packaging, the kit 100 may be displayed and sold in a freezer section of a retail establishment.

When purchased by a consumer, the pastry bag 104 is filled with the mixture 102 which comprises the pre-mixed ingredients. Thus, the mixture 102, upon being thawed, can be piped through an opening formed in the pastry bag 104 when the vertex 108 is separated from the remainder of the pastry bag 104 along the vertex separation line 110. According to an embodiment, the kit 100 can include one or more tips (not shown), which can be attached to the pastry bag 104 to allow for the mixture 102 to form a pattern as it is piped through a tip. In this embodiment, a kit 100 that includes a mixture 102 comprising frosting (e.g., buttercream, etc.) can include a plastic, disposable pastry tip, for creating decorous patterns.

According to an embodiment, the mixture 102 can be frozen cake batter. It is to be appreciated that the frozen cake batter can be frozen cupcake batter or frozen batter for substantially any other type of cake. It is contemplated that the frozen cake batter can be substantially any flavor cake batter. According to an embodiment, the frozen cake batter may be vanilla flavored. In another embodiment, the frozen cake batter may be chocolate flavored. However, it is to be appreciated that any other flavor of frozen cake batter is intended to fall within the scope of the claims appended hereto.

As previously noted, in an embodiment, the frozen cake batter may be made from all natural ingredients. For instance, the frozen cake batter may include no preservatives, no hydrogenated oils, and no unsaturated fats with trans-isomer fatty acids (e.g., trans fats). The frozen cake batter includes all ingredients for making a cake (e.g., cupcake, etc.), and hence, the frozen cake batter is ready for baking. Thus, a consumer that purchases the kit 100 need not add any additional ingredients to the mixture 102 prior to baking, thereby making cake preparation more convenient, simpler, less messy, and less time consuming than is possible using conventional techniques. Rather than having to purchase specific ingredients and mix these additional ingredients (e.g., in a bowl, etc.), using this invention, the consumer can thaw the frozen cake batter, pipe the thawed cake batter into a cake tray (e.g., cupcake tray, etc.), and bake, with or without using any utensils other than a baking mold or tray.

Moreover, in contrast to conventional cake batter that can turn out to be flat if frozen, thawed, and baked, the frozen cake batter of this invention rises when thawed and baked. Accordingly, the kit and method of this invention yields cakes with textures comparable to textures of cakes baked from batter that is not frozen and thawed.

Pursuant to an embodiment in which the mixture 102 comprises frozen frosting for bakery goods, it is contemplated that the frozen frosting can be substantially any flavor. For instance, the frozen frosting can be vanilla or chocolate flavored; yet, it is contemplated that substantially any other flavored frosting is intended to fall within the scope of the claims appended hereto. The frozen frosting can be buttercream frosting, for instance; yet, it is to be appreciated that other types of frosting are intended to fall within the scope of the hereto appended claims.

In the same manner as is discussed above respecting frozen cake batter, in an embodiment, the frozen frosting can be made with all natural ingredients. Moreover, additional ingredients may, but need not be, added to the frozen frosting if desired. Once the frozen frosting has been thawed to room temperature, the frosting may be piped out through the opening formed in the pastry bag 104 when the vertex 108 is separated from the remainder of the pastry bag 104.

In an embodiment, the flavor of the mixture 102 may be customizable by the consumer. In addition, since the flavor of the mixture 102 is customizable as described herein, the kit 100 can be used in a flexible manner by a consumer. For instance, the consumer can thaw the mixture 102 and add in additional optional ingredients to vary the flavor of the mixture 102. According to various embodiments, crushed cookies, flavored chips, jams, extracts, liquor, or substantially any other ingredient can be added to the mixture 102 in the pastry bag 104 once the mixture 102 has been thawed. Thereafter, the mixture can be kneaded and piped out of the pastry bag 104. Pursuant to an embodiment, the kit 100 can additionally include a sealing mechanism, such as an integral zipper 114, or a clip, twist tie, adhesive, or the like, which can be used to close the pastry bag 104 after additional optional ingredients have been added to the mixture. Since the additional, optional ingredients can be added to the mixture 102 in the pastry bag 104, it is not necessary to use a bowl or other utensil to mix ingredients, thereby creating an easier and less messy baking experience. In this manner, the large pastry bag may be utilized as a mixing bowl, and provides a receptacle for the mixture to be kneaded directly in the pastry bag.

For example, according to an embodiment, a consumer may purchase a kit that includes frozen vanilla cake batter, and may add guava jam to the batter, knead the batter in the bag, pipe the batter into a cupcake tray, and then bake the batter in the cupcake tray. In this example, a consumer using the method or kit of the invention can produce fresh, home baked guava cupcakes. In a further example, the consumer can purchase a kit that includes frozen vanilla buttercream frosting, can add whipped cream cheese to the vanilla buttercream frosting in the pastry bag, knead the frosting in the pastry bag, and pipe the cream cheese buttercream frosting on top of the baked guava cupcakes. It is to be appreciated, however, that the above illustrations are presented as an example, and the claimed subject matter is not so limited.

In an embodiment, the amount of the mixture 102 included in the pastry bag 104 may be no heavier than 2½ pounds. For example, for a kit 100 packaged to be sold in a supermarket, the amount of the mixture 102 can be approximately 13.5 ounces, or any other weight of less than 40 ounces. Pursuant to another example for a kit 100 packaged, to be sold in a super club, the amount of the mixture 102 can be approximately 18 ounces. Yet it is contemplated that other amounts of the mixture 102 are intended to fall within the scope of hereto appended claims. For instance, if the mixture 102 is frozen chocolate cake batter then the pastry bag 104 can be filled with approximately 13.5 ounces of frozen chocolate cake batter. Suggested amounts of cake batter can yield approximately 24 mini cupcakes. Moreover, if the mixture 102 is frozen buttercream frosting, then approximately 12 ounces of the buttercream frosting can be included in the pastry bag 104. Accordingly, the amount of the mixture 102 filling the pastry bag 104 can allow for kit 100 to be sold in the retail market to consumers.

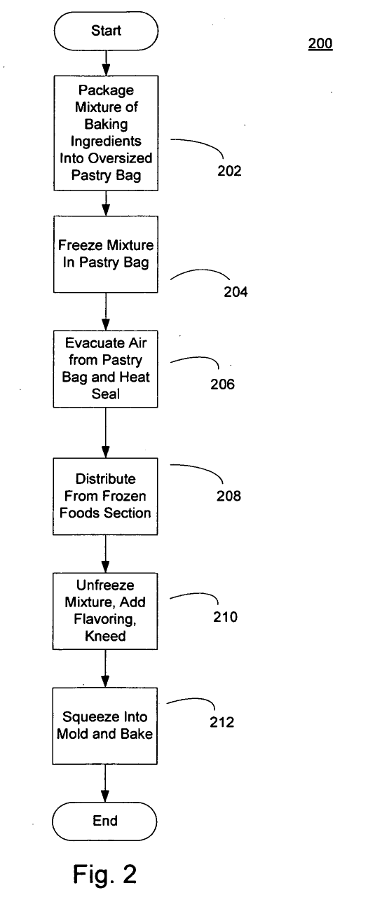

FIG. 2 illustrates a methodology relating to distribution of a mixture of ingredients for bakery goods in a frozen state. While, for purposes of simplicity of explanation, the methodology is shown and described as a series of acts, it is to be understood and appreciated that the methodology is not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, a subset of the illustrated acts may not be required to implement a methodology in accordance with one or more embodiments.

FIG. 2 illustrates a methodology for preparing and distributing the product. At 202 ingredients for a premixed, unbaked, and ready for baking mixture for bakery goods can be mixed and dispensed into a large pastry bag. According to an embodiment, the batter can be cake batter (e.g., cupcake batter, etc.).

At 204, the pre-mixed, unbaked, and ready for baking mixture of ingredients for bakery goods packaged in the pastry bag can be frozen. The pre mixture of ingredients is frozen shortly after mixing, and may be frozen quickly. According to an embodiment, the mixture of ingredients can be flash frozen or frozen in a blast freezer.

At 206, the frozen mixture of ingredients has the air eliminated or evacuated from the pastry bag, and is heat sealed to prevent the reintroduction of air. At 210, the pastry bag may be boxed and case packed in a cold packaging room for distribution and sale to consumers through a freezer section of a retail establishment. Examples of the retail establishment include, but are not limited to, a super market, a super club, a grocery store, convenience store, or the like. By way of another example, the frozen, pre-mixed, unbaked, and ready for baking mixture of ingredients for bakery goods can be distributed to a wholesaler, a distributor, a retailer, or the like. Since the mixture is ready for baking, a customer can thaw the frozen, pre-mixed, unbaked, and ready for baking mixture 210, pipe the thawed mixture from the pastry bag with or without adding other ingredients 212, and bake the mixture.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of making a baked item using a pre-mixed, unbaked, and ready for baking mixture of ingredients for bakery goods, comprising the steps of:
packaging a pre-mixed, unbaked, and ready for baking mixture of ingredients for bakery goods in a pastry bag, said pastry bag having a vertex, wherein said mixture of ingredients comprises at least one of batter, dough or filling;
freezing said mixture of ingredients in said pastry bag;
sealing said pastry bag with an airtight seal;
distributing said mixture of ingredients for sale to consumers by placing said mixture of ingredients in a freezer section of a retail establishment;
purchasing said mixture of ingredients;
thawing said mixture of ingredients and kneading said mixture in said pastry bag to prepare said mixture of ingredients for baking;
removing a vertex of said pastry bag to create an opening of sufficient size for said mixture of ingredients to be squeezed from said pastry bag;
squeezing said mixture of ingredients from said pastry bag into a mold;
baking said mixture of ingredients for a time and at a temperature sufficient to cause said mixture of ingredients to rise and bake.

2. The method of making a baked item as claimed in claim 1, further comprising said pastry bag being made of polyethylene.

3. The method of making a baked item as claimed in claim 2, further comprising said pastry bag being substantially triangular.

4. The method of making a baked item as claimed in claim 1, further comprising the step of opening said pastry bag and inserting one or more additional ingredients after said mixture of ingredients has thawed.

5. The method of making a baked item as claimed in claim 4, further comprising reclosing said pastry bag prior to kneading said mixture of ingredients and said additional ingredients.

6. The method of making a baked item as claimed in claim 1 wherein said step of freezing said mixture of ingredients is done by flash freezing or blast freezing.

7. The method of making a baked item as claimed in claim 1 wherein exposure of said premixed mixture of ingredients is minimized such that said mixture of ingredients does not rise prior to said mixture of ingredients being frozen.

8. A kit, comprising:
point of sale packaging;
a pastry bag within said point of sale packaging, said pastry bag including a separation line near a vertex; and
a pre-mixed, unbaked, and ready for baking mixture of ingredients for bakery goods included within the pastry bag, wherein said mixture of ingredients is in a frozen state and comprises at least one of batter, dough, or filling.
